(19) United States
(12) Patent Application Publication
(10) Pub. No.: US 2012/0279742 A1
(43) Pub. Date: Nov. 8, 2012

(54) Hand-Held Power Tool

(75) Inventor: Jochen Roser, Leonberg-Gebersheim (DE)

(73) Assignee: Robert Bosch GmbH, Stuttgart (DE)

(21) Appl. No.: 13/503,315

(22) PCT Filed: Oct. 8, 2010
(86) PCT No.: PCT/EP2010/065121

§ 371 Date: Jul. 23, 2012

(30) Foreign Application Priority Data
Oct. 23, 2009 (DE) 102009045942.1

(51) Int. Cl. B25F 5/00

(52) U.S. Cl. 173/176

(57) ABSTRACT

The disclosure relates to a hand-held power tool including a housing having a handle portion, a tool portion for a tool that can be driven to move linearly and/or oscillate, an operator part on the housing side for the activation of the tool and/or the power tool on the user side, a drive unit for producing a working movement of the tool, an electronic unit for supplying the drive unit at least with open-loop control and/or closed-loop control signals, and an operating voltage unit for making an electrical DC voltage available. The drive unit includes at least one excitation actuator, especially an ultrasonic actuator, having a volume of an excitation-active material. The actuator is supplied with power by the operating voltage unit, when operated, and is controlled in an open or closed loop control by the electronic unit.

### PRIOR ART

The invention proceeds from a hand-held power tool which comprises a housing having a handle region, a tool region for a tool which can be driven in a linear and/or oscillating manner, a housing-mounted operator control part for activation of the tool and/or the power tool by a user, a drive unit for generating a working movement of the tool, an electronics unit for supplying at least open-loop and/or closed-loop control signals to the tool, an operating voltage unit for providing an electrical DC voltage, with the drive unit comprising at least one excitation actuator having a volume of excitation-active material, which excitation actuator is supplied with electrical power by the operating voltage unit during operation and is subjected to open-loop control or closed-loop control by the electronics unit.

Hand-held power tools are distinguished by the fact that they are portable and are held and controlled by hand by an operator during operation. To this end, said hand-held power tools are generally operated either using battery packs or by means of mains power. Power tools of this kind can be arranged, in particular, in a housing which is completely held by the user and is generally of integral design or else has a separate housing for the power supply system and electronics components.

In ultrasound-excited systems, piezoceramic disks are usually used as excitation actuators for generating the ultrasound oscillations. Said piezoceramic disks are excited by an electrical actuation circuit to mechanically oscillate, it then being possible to use these mechanical oscillations for the respective processing task. During operation, these piezoceramic disks are subject to very high compressive and tensile stresses on account of the generated mechanical oscillations. In the event of unpredictable shocks, the operation-related mechanical stress peaks can be added to said compressive and tensile stresses and overload the excitation actuator such that the endurance limit of the piezoceramic is exceeded.

### DISCLOSURE OF THE INVENTION

The invention proceeds from a hand-held power tool which comprises a housing having a handle region, a tool region for a tool which can be driven in a linear and/or oscillating manner, a housing-mounted operator control part for activation of the tool and/or the power tool by a user, a drive unit for generating a working movement of the tool, an electronics unit for supplying at least open-loop and/or closed-loop control signals to the drive unit, and an operating voltage unit for providing an electrical DC voltage, with the drive unit comprising at least one excitation actuator having a volume of excitation-active material, which excitation actuator is supplied with electrical power in the operating voltage unit during operation and is subjected to open-loop control or closed-loop control by the electronics unit.

It is proposed that an inertial sensor unit for detecting at least one acceleration component is coupled to the drive unit such that at least the drive unit is disconnected when at least one definable limit acceleration value is exceeded.

In this way, it is possible to prevent mechanical oscillations of the excitation actuator, which is in operation, of the drive unit being superimposed on the high impulse forces which occur in the event of the power tool falling or being struck, for example when the power tool collides with a hard object, and damaging or destroying said excitation actuator. The accelerations which precede the impulse or the acceleration force which occurs can be detected by means of the inertial sensor unit even before the possibly damaging mechanical impulse force occurs, with the inertial sensor unit disconnecting at least the drive unit when a definable limit acceleration or acceleration force is exceeded, so that said drive unit is protected against excessive loading in the event of an impact. Particularly in the case of integrally designed power tools in which the drive unit and the electronics unit are arranged in the same housing, the hand-held power tool has a high basic mass, so that a large mechanical impulse occurs in the event of the power tool falling onto or striking a fixed object. According to the invention, the inertial sensor unit detects at least one acceleration component, in particular a gravitational component in the case at least in which it falls freely and an acceleration corresponding to the acceleration due to gravity of approximately g=9.8 m/s² prevails, so that the drive unit can be disconnected in good time before an impact. An expedient limit value is, for example, g=9.81±0.05 m/s². Said drive unit may also be disconnected only after a short time delay, for example only after a few milliseconds, so that a rapid pulsed working movement does lead immediately to disconnection. If the acceleration lasts for less time than the time delay, this is identified as a working movement and not as a situation of the power tool falling and does not lead to disconnection.

It is feasible for the power tool to comprise a plurality of excitation actuators or further drive components, such as an electric motor. In this case, it is necessary to ensure that the inertial sensor unit automatically disconnects at least the excitation actuator, in particular which is composed of the piezoelectric material, which can be designed as a Langevin oscillator. Since the excitation-active material can be operated in a resonant oscillation state which is advantageous for operation, high shifts in volume with correspondingly extreme loading of the excitation-active material occur, it being possible for additional external impulse components which are already low to cause a risk of fracture, destruction or overloading, which reduces the service life, of the excitation-active material. In particular, the supply of energy by means of a battery or rechargeable battery or, alternatively or in addition, by mains power by means of a power supply unit causes the power tool to have a high mass, and therefore accelerations result in a high impulse force which can damage the excitation actuator which is operating, in particular in the case of an impact. The power tool, which can be used as a drill, hammer drill, cutting tool, grinding machine, mill, saw, welding device or the like, for example, is protected extremely effectively by means of the inertial sensor unit against mechanical damage or overloading of the excitation actuator, and therefore the service life can be increased and servicing intervals can be extended. Furthermore, automatic disconnection increases the operational safety for the operator since there is no longer any risk of injury by the falling and therefore uncontrolled machine after disconnection.

The inertial sensor unit can advantageously generate an “emergency switch-off signal” and switch the power tool or a drive component to a protected state before the sensitive drive electronics or drive mechanics suffer an impact shock. By way of example, a freefall sensor is known which identifies when the power tool is falling freely by means of a mechanical inertia element which is arranged between two electrodes. Said freefall sensor can be used, for example, as an acceleration sensor which is based on an electromechanical transducer which comprises piezoelectric elements for identifying a state of freefall. A method for identifying falling by means of a software monitoring driver can also be used, with a fall sensor identifying the state of falling and disconnecting sensitive elements of the power tool using appropriate software and/or moving said sensitive elements of the power tool to a safe position.

A hand-held power tool in which the drive unit comprises an excitation actuator having a volume of excitation-active material, in particular, is under consideration in this context. An excitation-active material of this kind can be a piezoelectric, generally ceramic, material. In addition, a magnetostrictive material is also a feasible excitation-active material, with an alternating magnetic field causing a change in volume.

Hand-held power tools are at risk of falling or being subject to unintentional shocks which are triggered by the power tool striking another body during a control movement. The high impulse forces which occur locally in the tool region in such cases can damage or destroy, in particular, piezoceramic disks or magnetostrictive volume bodies in connection with the working forces which are present during operation in any case. Therefore, piezoceramic disks are usually used to generate the ultrasound oscillations in ultrasound-excited systems. Said piezoceramic disks are excited to mechanically oscillate in a resonant manner by an electrical actuation circuit, said resonant mechanical oscillation then being used for the respective processing tasks. During operation of the power tool, these piezoceramic disks are subject, as a result of use, to very strong compressive and tensile stresses on account of the generated mechanical oscillations. If the tool falls, there is a risk of the stress peaks of impact and operation adding up and thereby exceeding the endurance limit of the ceramic.

According to an advantageous refinement, the inertial sensor unit can be arranged in the electronics unit. The electronics unit, which usually controls the excitation actuator by means of high-frequency electrical supply signals, can be easily equipped with an inertial sensor unit which can immediately interrupt the supply of energy between the electronics unit and the excitation actuator in the event of disconnection. Since an inertial sensor unit usually comprises electronic components, said inertial sensor unit can be integrated in the electronics unit in one operation in a space-saving and cost-effective manner.

According to a further advantageous refinement, the inertial sensor unit comprises a semiconductor sensor, in particular a MEMS sensor (Micro-Electro-Mechanical-System). MEMS sensors have extremely small dimensions in the micrometer range and can be integrated on a substrate or chip using semiconductor technology in a particularly space-saving and cost-effective manner. Therefore, inertial sensor units which comprise a MEMS sensor are extremely easily available, have a long service life and are available in a variety of embodiments.

According to an additional or alternative refinement, the inertial sensor unit can comprise a piezoelectric or piezomechanical acceleration sensor. In this case, a piezoceramic sensor plate converts dynamic pressure fluctuations into electrical signals which can be processed further. The pressure fluctuations are generated by a seismic mass which is fixed to the piezoceramic and which has a retroactive effect on the piezoceramic when the overall system accelerates. Acceleration sensors of this kind are highly suitable as shock sensors in order to detect hard shocks on the power tool. Since the electronics unit serves, in particular, to control a piezoelectric actuator, evaluation of a piezoelectric acceleration sensor can be taken into consideration in a particularly simple manner in the circuit design of the electronics unit.

In principle, the inertial sensor unit can identify at least one single acceleration component. According to an advantageous refinement, the inertial sensor unit is designed to detect two acceleration components, in particular all three acceleration components which are at right angles to one another. Detection of two, in particular three, acceleration components allows acceleration to be detected in any desired handling direction of the power tool, so that even the situation of the power tool falling when it is not in use can be identified by the acceleration sensor. Accelerations or shocks in any direction of the power tool can be identified by means of a 2D or 3D acceleration sensor.

According to a further advantageous refinement, the inertial sensor unit can be designed to detect at least one, preferably two, in particular three, position components. To this end, the inertial sensor unit can interact with the electronics unit such that the drive unit is disconnected when a defined position is left. Therefore, an inertial sensor which, in addition to identifying an acceleration component, is likewise designed to identify a position component can deactivate a drive unit if the power tool leaves a predefinable use position. An inertial sensor unit of this kind can be used, for example, as an “electronic spirit level”, to allow operation only in a predefined position of the power tool, and secondly realize a protective sensor system in order to prevent a user from unintentionally switching on the power tool when it is in an unfavorable holding position. A large number of commercially available acceleration sensors additionally have a position identification functionality, and therefore these can advantageously be used for defined positioning of the power tool and for increasing the protective effect for the user.

In principle, the inertial sensor unit disconnects at least the drive unit when a definable limit acceleration value is exceeded. According to an advantageous refinement, the inertial sensor unit can interact with the electronics unit for rapid disconnection of the drive unit, in particular by forming an electrical short circuit of the excitation actuator or by biasing the excitation actuator in a defined manner. Therefore, rapid disconnection can be realized, for example, by applying a predefinable DC voltage to the excitation actuator or by connecting a short circuit or attenuating resistor to the excitation actuator since the electrical energy which is stored in the excitation actuator is instantly discharged in the event of a short circuit or damping, and said excitation actuator can therefore be immediately switched to an off-state. In a further variant embodiment, the excitation actuator can be anticyclically excited by the actuation electronics, and therefore the ultrasound oscillations are actively damped. Rapid disconnection makes it possible, in the event of short falling or shock movements, to rapidly disconnect the excitation actuator, so that the protective effect is improved even in the case of low falling heights or short acceleration actions.

According to an advantageous refinement, the inertial sensor unit can also interact with the electronics unit for disconnection of the electrical DC voltage of the operating voltage unit. In this case, the inertial sensor unit disconnects the operating voltage unit, which provides the electrical DC voltage, from the electronics unit and the drive unit, so that the power tool has no power, in order to protect both the drive unit and also the electronics unit against electrical short circuits and damage. Disconnecting the operating voltage unit also prevents an existing rechargeable battery or a drive battery being short-circuited, as a result of which a defect in or destruction of the energy storage means and danger to the user due to a fire resulting from a short circuit or explosions of the rechargeable battery or battery can be prevented.

In a further advantageous refinement, the inertial sensor unit can interact with the electronics unit in order to lock or deactivate the operator control part. If the inertial sensor unit identifies a critical acceleration, the operator control part can be deactivated, so that a user has to first unlock or activate the operator control part after the tool is struck or falls, and therefore is forced to check functioning of the power tool. Therefore, for recommissioning purposes, provision can be made for an acknowledgement signal to first have to be output, for example by means of a reset button, and/or for the operator to have to first switch off and then switch on the appliance again, and/or for it to be possible for said appliance to be switched on again only after a prespecified waiting time or another suitable measure. Appropriate devices can be provided for these purposes.

Permanent deactivation or locking is also feasible, and therefore, after a fall or shock, the appliance first has to be checked by servicing personnel in order to unlock or activate the operator control part. The drive unit and the excitation actuator can also be carefully checked as part of a servicing inspection of this kind, as a result of which targeted servicing is achieved.

In a further advantageous refinement, the power tool can comprise an output power sensor or input power sensor for measuring the output mechanical output power or excitation amplitude and, respectively, the received electrical input power, it being possible to select at least the limit acceleration value in dependence on the measured power. If the drive actuator receives, for example, a low input power, or outputs a low mechanical output power or excitation amplitude, the excitation actuator is subjected to only low loading. Accordingly, correspondingly higher accelerations or higher shock forces can be received by the excitation actuator without said excitation actuator being put at risk. In the event of a tool being operated at maximum load, the excitation actuator is in a highly sensitive, mechanically limit-stable state, and therefore even small acceleration components can cause a defect in or destroy the excitation actuator. It is accordingly advantageous to adaptively sensitize the tool to accelerations which occur in the event of full-load operation by measuring the input or output power of the power tool, so that the inertial sensor unit can protect the power tool against damage in as robust and effective a manner as possible.

Mechanical oscillations which lie in the range of the drive frequency of the excitation actuator can occur during operation of the power tool. Acceleration forces which occur and have to be observed by the inertial sensor unit generally have a substantially lower frequency, and therefore the acceleration or force components caused lie in a lower frequency range. In order to improve the detection accuracy of the inertial sensor unit, it is accordingly advantageous to provide a filter device, in particular a low-pass filter device, for filtering out acceleration forces within the inertial sensor unit which are typical of the tool, said filter device filtering frequency components which are generated by the drive unit out of the measured acceleration components in order to allow improved identification accuracy of low-frequency acceleration or shock components. The sensor accuracy and therefore the safety disconnection behavior of the power tool can be decisively improved as a result.

### DRAWINGS

Further advantages can be gathered from the following description of the drawings. Exemplary embodiments of the invention are illustrated in the drawings. The drawings, the description and the claims contain numerous features in combination. A person skilled in the art will expediently also consider the features on their own and combine them to form meaningful further combinations.

In the drawings:

FIG. 1 shows an exemplary embodiment of a hand-held power tool having an inertial sensor unit in a refinement as a cutting appliance;

FIG. 2 shows a further exemplary embodiment of a hand-held power tool having an inertial sensor unit in a refinement as a drill;

FIG. 3 shows a basic schematic diagram of a protective circuit of an excitation actuator having an inertial sensor unit;

FIG. 4 shows a further basic schematic diagram of a protective circuit of an excitation actuator having an inertial sensor unit; and

FIG. 5 schematically shows the filter characteristic of a low-pass filter for filtering out working movements which are typical of the tool.

### EMBODIMENTS OF THE INVENTION

In the figures, identical or identically acting components are provided with the same reference symbols.

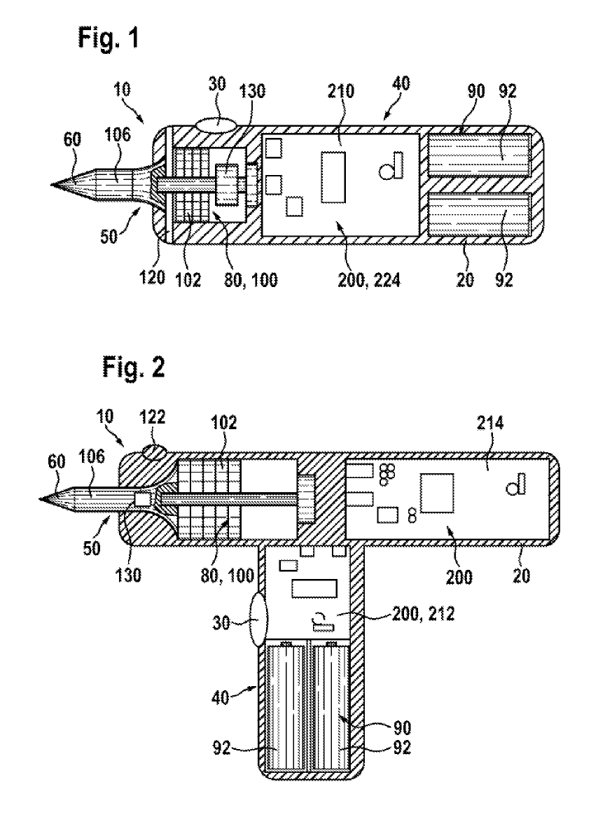

In order to explain the invention, FIGS. 1 and 2 show different examples of hand-held power tools 10. FIG. 1 shows a cutting appliance having an elongate housing design; FIG. 2 shows a drill having a T-shaped housing design.

The hand-held power tool 10 comprises a housing 20 having a handle region 40. An operator holds the power tool 10 on the handle region 40 and can control the power tool 10. The power tool 10 also comprises a tool region 50 for a tool 60, for example a blade (FIG. 1) or a drill (FIG. 2) or another tool corresponding to another type of appliance, which can be driven in a linear and/or oscillating manner.

A housing-mounted operator control part 30 can be used for activation of the tool 60 and/or the power tool 10 by a user. A drive unit 80 is arranged in the housing 20, said drive unit comprising only one drive component, which is formed by an excitation actuator 100, in the examples according to FIG. 1 and FIG. 2. Said excitation actuator can be in the form of a piezo-excited Langevin oscillator (also called piezoactuator) which comprises a volume of piezoelectrically active material 102, for example piezoceramic disks which are compressed and which change in length when an electrical voltage is applied. When a high-frequency electrical voltage is applied, ultrasound is generated in a manner which is known per se, said ultrasound being conducted to a tool 60 by means of a coupling element 106. The coupling element 106 can be a sonotrode which is known per se. The length and the design and also the material of the coupling element 106 determine a resonant frequency of the excitation actuator 100. The tool 60 can also influence the resonant frequency.

An electronics unit 200 which is arranged in the housing 20 is used to supply at least open-loop and/or closed-loop control signals to the drive unit 80, and to supply voltage to the excitation actuator 100. An operating voltage unit 90, in this case a battery or rechargeable battery pack containing batteries or rechargeable batteries 92, is used to provide an electrical DC voltage for the electronics unit 90 which converts the operating voltage into a high-frequency voltage signal with which the excitation actuator 100 is excited in the desired manner to oscillate.

The electronics unit 200 is designed to operate the at least one excitation actuator 100 at a resonant frequency. In this case, the electronics unit 200 comprises a closed-loop control unit 224 for adjusting the resonant frequency of the excitation actuator 100. Activation of the tool 60 by the activation actuator 30 can be indicated by a signaling means 122 (FIG. 2).

In FIG. 1, the electronics unit 200 is integrated on a single printed circuit board 210 in a particularly space-saving manner. In FIG. 2, the electronics unit is divided between two printed circuit boards 212, 214, with one being arranged in the main part and one being arranged in the handle part, which projects transversely from the main part, of the T-shaped housing 20.

An inertial sensor unit 130 is arranged directly on or close to the excitation actuator 100 which comprises a piezoelectric active material 102. Therefore, the inertial sensor unit can directly detect an acceleration or shock force which acts on the actuator unit 102. Furthermore, the inertial sensor unit 130 is connected (not illustrated) to the electronics unit 200 in order to rapidly disconnect the drive unit 100 in the event of a limit acceleration value being exceeded.

In the embodiment according to FIG. 2, the inertial sensor unit 130 is arranged in the sonotrode 106. Therefore, the inertial sensor unit 130 is located directly at the point of maximum mechanical loading, and therefore an additional acceleration component has an additive effect on the accelerations which are generated by the excitation actuator, it being possible for the inertial sensor unit 130 to thereby clearly identify that an overall acceleration loading has been exceeded, in order to effectively protect the excitation actuator 102.

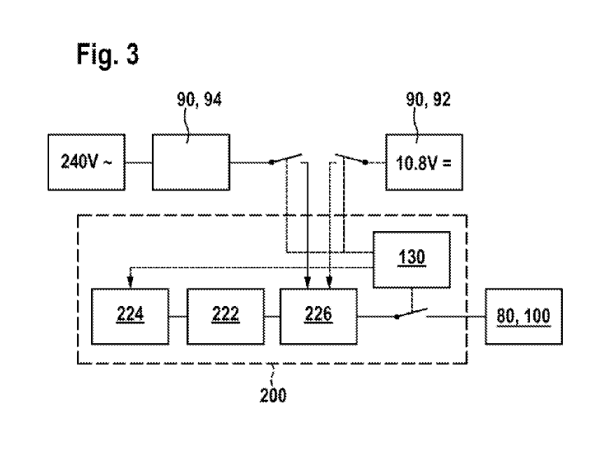

FIG. 3 shows a basic schematic diagram of an actuation arrangement of the excitation actuator 100, for example in the form of a piezoactuator 100 having a AC voltage supply from a mains power supply system (for example 240 V˜) or a DC voltage supply by a battery pack (for example 10.8 V=), it being possible for an inertial sensor unit 130 to electrically disconnect the excitation actuator 100 and the electronics unit 200. When mains power is supplied to the electronics unit 200, for example with an AC voltage, an assembly 94 which rectifies and smoothes the AC voltage is provided. The electronics unit 200 comprises a power generation unit 222 into which the DC voltage is fed and which is coupled to the excitation actuator 100 by means of a corresponding filter unit 226 and the decoupling switch of the inertial sensor unit 130. A closed-loop control unit 224 provides the closed-loop control signals for the excitation actuator 100.

If the inertial sensor unit 130 (FIG. 1, FIG. 2) identifies an acceleration which exceeds a predeterminable limit acceleration value, the switches which are coupled to the inertial sensor unit 130 are opened. Therefore, the inertial sensor unit 130 firstly disconnects the supply of electrical power to the excitation actuator 100 from the electronics unit 200 and secondly disconnects the operating voltage unit 90 from the electronics unit 200, and therefore the rechargeable battery 92 and the mains supply component can be protected against a short circuit and the electronics unit 200 can be protected against an overvoltage. In a further embodiment, the inertial sensor unit 130 can output a signal to the closed-loop control unit 224 in the event of disconnection, said closed-loop control unit then rendering the power generation unit 222 inactive.

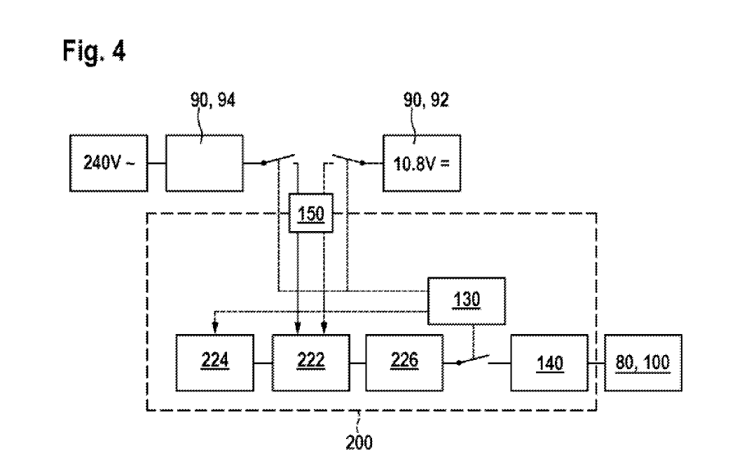

The schematic diagram of FIG. 4 corresponds largely to that of FIG. 3, but the operating voltage unit 90 also comprises an input power sensor 150 which measures the electrical power which flows from the operating voltage unit 90 and flows to the electronics unit 200. The electronics unit 200 also comprises an output power sensor 140 which determines the electrical output power which is delivered by the electronics unit 200 to the excitation actuator 100. The power values of the input power sensor 150 and of the output power sensor 140 are transmitted to the inertial sensor unit 130. By virtue of taking into consideration the power consumption or power output, the inertial sensor unit permits, particularly in the case of low power values, a higher limit acceleration or limit forces than is possible during full-load operation, that is to say at high input and output powers or input and output amplitudes.

Therefore, the inertial sensor unit 130 can be adaptively matched to the respective electrical and mechanical loading of the power tool, and allows a maximum degree of robustness of the machine to shocks and falls since the disconnection limit value is based on the mechanical loading of the drive unit. Therefore, the sensitivity of the protective mechanism can be optimally adjusted.

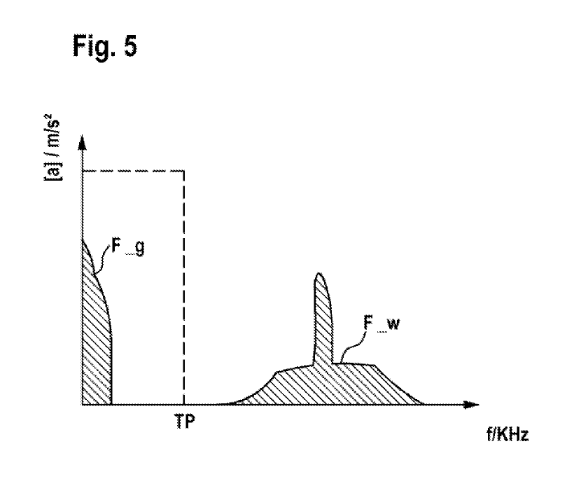

FIG. 5 schematically shows a frequency graph for occurring acceleration values as the magnitude of the acceleration of the power tool 10 plotted against the frequency. An expedient working frequency of the tool is, for example, in the region of 40 kHz (in particular 40 kHz ±500 Hz). Working movements, which are typical of a tool, having a broad spectrum of acceleration values on account of the working intervention can be seen in a high-frequency range of the graph, and a pronounced peak can be seen in the region of the operating frequency (for example around approximately 40 kHz) with accelerations F_w which are typical of the tool and which are caused by the controlled excitation of the excitation actuator 100 and are influenced by resonant and damping effects of the mass of the power tool. Acceleration values F_g which act on the power tool on account of mechanical shocks and external accelerations occur at low frequencies. In order to increase the sensitivity of the inertial sensor unit 130, undesired interference components can be filtered out by means of a low-pass filter TP, the limit frequency of said low-pass filter being selected, for example at 10 kHz, such that it can filter out working movements which are typical of the tool. As a result, the sensitivity of the inertial sensor unit 130 to identifying relevant external mechanical loadings, accelerations and interference impulses can be increased.

The longevity, working quality and the user protection ability of a manually operated ultrasound-based power tool are improved by means of the invention.

1. A hand-held power tool comprising:
a housing having a handle region;
a tool region for a tool which can be driven in a linear and/or oscillating manner;
a housing-mounted operator control part for activation of the tool and/or the power tool by a user;
a drive unit for generating a working movement of the tool;
an electronics unit for supplying at least open-loop and/or closed-loop control signals to the drive unit; and
an operating voltage unit for providing an electrical DC voltage,
wherein the drive unit includes at least one excitation actuator, in particular an ultrasound actuator, having a volume of excitation-active material,
wherein the excitation actuator (i) is supplied with electrical power by the operating voltage unit during operation, and (ii) is subjected to open-loop control or closed-loop control by the electronics unit, and
wherein an inertial sensor unit for detecting at least one acceleration component is coupled to the drive unit such that at least the drive unit is disconnected when at least one definable limit acceleration value is exceeded.

2. The hand-held power tool as claimed in claim 1, wherein the inertial sensor unit is arranged in the electronics unit.

3. The hand-held power tool as claimed in claim 1, wherein the inertial sensor unit includes a semiconductor sensor, in particular a MEMS sensor.

4. The hand-held power tool as claimed in claim 1, wherein the inertial sensor unit includes a piezoelectronic acceleration sensor.

5. The hand-held power tool as claimed in claim 1, wherein the inertial sensor unit is designed to detect one, preferably two, in particular three, acceleration components.

6. The hand-held power tool as claimed in claim 1, wherein:
the inertial sensor unit is designed to detect at least one, preferably two, in particular three, position components, and
the drive unit is disconnected when a definable position is left.

7. The hand-held power tool as claimed in claim 1, wherein the inertial sensor unit interacts with the electronics unit for rapid disconnection of the drive unit, in particular for forming an electrical short circuit of the excitation actuator.

8. The hand-held power tool as claimed in claim 7, wherein, for rapid disconnection of the drive unit, provision is made for
forming an electrical short circuit of the excitation actuator, and/or
connecting a DC voltage, and/or
connecting an attenuating resistor, and/or
anticyclic excitation for actively damping the excitation actuator.

9. The hand-held power tool as claimed in claim 1, wherein the inertial sensor unit interacts with the electronics unit in order to disconnect the electrical DC voltage of the operating voltage unit.

10. The hand-held power tool as claimed in claim 1, wherein the inertial sensor unit interacts with the electronics unit in order to lock or deactivate the operator control part.

11. The hand-held power tool as claimed in claim 10, wherein, after the operator control part is deactivated, recommissioning can be implemented by
activating an acknowledgement signal, and/or
switching off and switching on the power tool, and/or
switching on said power tool again after a prespecified waiting time.

12. The hand-held power tool as claimed in claim 1, further comprising:
an output power sensor or input power sensor for measuring the output mechanical output power and/or output amplitude and, respectively, a received electrical input power,
wherein it is possible to select at least the limit acceleration value in dependence on the measured values of power and/or amplitude.

13. The hand-held power tool as claimed in claim 1, wherein the inertial sensor unit is coupled to a filter device for filtering out working movements which are typical of the tool.
